(19) United States
(12) Patent Application Publication
(10) Pub. No.: US 2026/0118471 A1
(43) Pub. Date: Apr. 30, 2026

(54) Method for Automatically Determining Positioning Signal Strength in a Tire Pressure Sensor System

(71) Applicant: SYSGRATION LTD., TAIPEI CITY (TW)

(72) Inventors: WEN-XIAN HUANG, TAIPEI CITY (TW); TSUNG-HSIEN LEE, TAIPEI CITY (TW)

(21) Appl. No.: 19/360,999

(22) Filed: Oct. 17, 2025

(30) Foreign Application Priority Data
Oct. 24, 2024 (TW) 113140606

(51) Int. Cl. G01S 5/02; B60C 23/04; G01L 17/00

(52) U.S. Cl. CPC G01S 5/0269; B60C 23/0416; G01L 17/00

(57) ABSTRACT

A method for automatically determining appropriate positioning signal strength in a tire pressure sensor system, includes the following steps: A signal receiver sets front and rear wheel determination conditions according to its installation position on a vehicle body. When the vehicle body starts moving, the signal receiver receives signal strength feedback from each tire pressure sensor at multiple angular positions, and the signal receiver determines an optimal angular position for reading signal strength of each tire pressure sensor based on the signal strength feedback from each tire pressure sensor at the multiple angular positions. The method of the present invention achieves improvement over the previous positioning method of using the strength of signals returned by tire pressure sensors to determine the orientation of tire pressure sensors, which had the problem that misjudgment of front and rear wheel positions would occur under specific circumstances.

### BACKGROUND OF THE INVENTION

### 1. Fields of the invention

The present invention relates to a method for automatically determining positioning signal strength in a tire pressure sensor system, which facilitates the precise identification by a vehicle host system of the wheel to which each tire pressure sensor belongs.

### 2. Descriptions of Related Art

Tire pressure values are important data concerning whether a vehicle body can travel safely. With the advancement of technology, the methods for detecting tire pressure values have also improved considerably. From the past when manual measurement had to be performed wheel by wheel, to the present where various electronic devices automatically measure and transmit data to monitoring screens for display, this is much more convenient.

Among these, a more common electronic device is the tire pressure sensor. Tire pressure sensors have built-in components related to tire pressure detection. When combined with battery-powered electronic modules, they are able to connect and share information with matched vehicle host systems, thereby enabling users to view tire pressure values on the vehicle host system. Generally speaking, a conventional vehicle body has four wheels, and therefore it is necessary to install four tire pressure sensors on the left front wheel, right front wheel, left rear wheel, and right rear wheel respectively. However, since the four tire pressure sensors are completely identical products, it is difficult for the vehicle host system to identify which wheel, left front wheel, right front wheel, left rear wheel, or right rear wheel, each tire pressure sensor's values belong to. Therefore, the conventional practice is for the host system to collect rotation direction information from each tire pressure sensor and the received wireless signal strength, thereby determining the orientation of each tire pressure sensor.

In addition to the aforementioned methods, newer positioning methods currently on the market also utilize the strength of signals returned by tire pressure sensors to determine the front and rear wheel positions of the tire pressure sensors. However, this method of using returned signal strength to determine front and rear wheel positions has problems in judgment. For example, when the receiver is configured by default at a position closer to the rear wheels, but the tire pressure sensor on the rear wheel happens to be at the angle farthest from the receiver when the receiver receives signals, while the tire pressure sensor on the front wheel also happens to be at the angle closest to the receiver, at this time the signal strengths of the front and rear wheel tire pressure sensors received by the receiver will be extremely similar, resulting in misjudgment.

Based on the aforementioned content, it can be understood that the current positioning method of using the strength of signals returned by tire pressure sensors to determine the orientation of tire pressure sensors has the problem that misjudgment of front and rear wheel positions will occur under specific circumstances. This problem indeed needs to be improved in order to reduce the probability of misjudgment during the operation of the aforementioned positioning method.

The present invention intends to provide a method for automatically determining positioning signal strength in a tire pressure sensor system to eliminate shortcomings mentioned above.

### SUMMARY OF THE INVENTION

The present invention relates to a method for automatically determining positioning signal strength in a tire pressure sensor system, and the method comprising the following steps:

A signal receiver sets front and rear wheel determination conditions according to its installation position on a vehicle body, when the signal receiver is installed at a position on the vehicle body closer to the front wheels, the front and rear wheel determination conditions are that a tire pressure sensor with stronger feedback signal strength is located on a front wheel, and a tire pressure sensor with weaker feedback signal strength is located on a rear wheel. When the signal receiver is installed at a position on the vehicle body closer to the rear wheels, a tire pressure sensor with stronger feedback signal strength is located on a rear wheel, and a tire pressure sensor with weaker feedback signal strength is located on a front wheel. When the vehicle body starts moving, the signal receiver receives signal strength feedback from each tire pressure sensor at multiple angular positions, the signal receiver determines an optimal angular position for reading signal strength of each tire pressure sensor based on the signal strength feedback from each tire pressure sensor at the multiple angular positions. The determination conditions for an optimal angular position are that the optimal angular position of a tire pressure sensor having overall stronger signal strength feedback at various angles is the angular position when the strongest signal is fed back. An optimal angular position of a tire pressure sensor having overall weaker signal strength feedback at various angles is the angular position when the weakest signal is fed back.

Preferably, each tire pressure sensor detects a current angular position by using an accelerometer, and feeds back an information of the current angular position to the signal receiver.

The determination method of the present invention enables the signal receiver to determine the optimal angular positions when receiving feedback signals from front and rear wheel tire pressure sensors, so as to prevent the tire pressure sensors on the front and rear wheels from being at angles that easily cause the receiver to make misjudgments when the signal receiver reads the strength signals fed back by each tire pressure sensor. The method of the present invention achieves improvement over the previous positioning method of using the strength of signals returned by tire pressure sensors to determine the orientation of tire pressure sensors, which had the problem that misjudgment of front and rear wheel positions would occur under specific circumstances.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a schematic diagram showing signal strength feedback from tire pressure sensors on front and rear wheels at multiple angular positions during actual application of the present invention, and

FIG. 2 is a schematic diagram showing tire pressure sensors on front and rear wheels at optimal angular positions for signal strength feedback during actual application of the present invention.

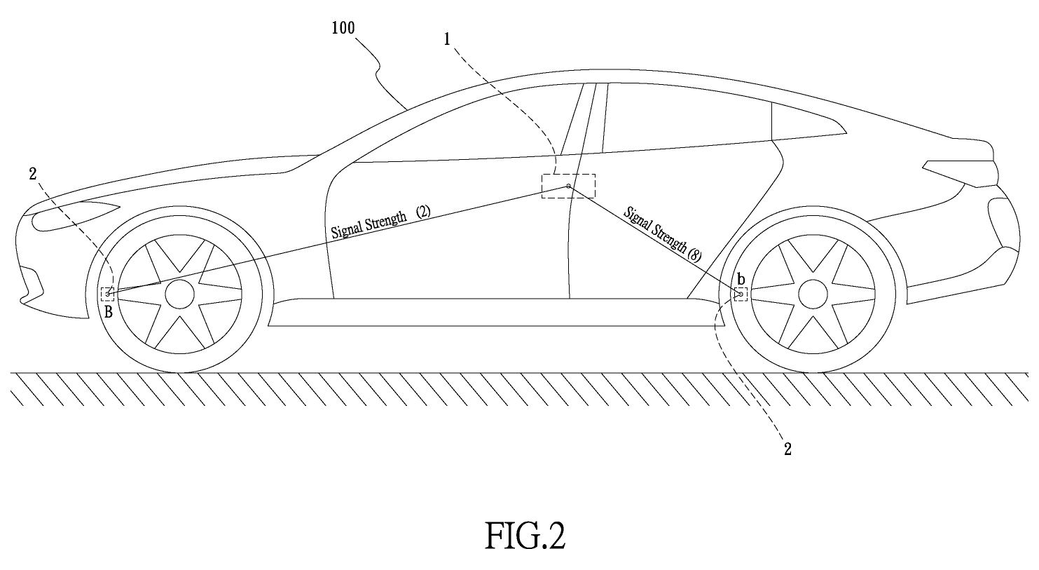

### DETAILED DESCRIPTION OF THE PREFERRED EMBODIMENT

The present invention provides a method for automatically determining appropriate positioning signal strength in a tire pressure sensor system, and comprises the following steps: a signal receiver 1 sets front and rear wheel determination conditions according to its installation position on a vehicle body 100. When the signal receiver 1 is installed at a position on the vehicle body 100 closer to the front wheels, the front and rear wheel determination conditions are that a tire pressure sensor 2 with stronger feedback signal strength is located on a front wheel, and a tire pressure sensor 2 with weaker feedback signal strength is located on a rear wheel. When the signal receiver 1 is installed at a position on the vehicle body 100 closer to the rear wheels, a tire pressure sensor 2 with stronger feedback signal strength is located on a rear wheel, and a tire pressure sensor 2 with weaker feedback signal strength is located on a front wheel. When the vehicle body 100 starts moving, the signal receiver 1 receives signal strength feedback from each tire pressure sensor 2 at multiple angular positions. The signal receiver 1 determines an optimal angular position for reading signal strength of each tire pressure sensor 2 based on the signal strength feedback from each tire pressure sensor 2 at the multiple angular positions. The determination conditions for the optimal angular position are that the optimal angular position of a tire pressure sensor 2 having overall stronger signal strength feedback at various angles is the angular position when the strongest signal is fed back, and the optimal angular position of a tire pressure sensor 2 having overall weaker signal strength feedback at various angles is the angular position when the weakest signal is fed back.

Each tire pressure sensor 2 detects its current angular position by using an accelerometer and feeds back this information to the signal receiver 1, so that the signal receiver 1 can determine the current angular position when each tire pressure sensor 2 feeds back signal strength.

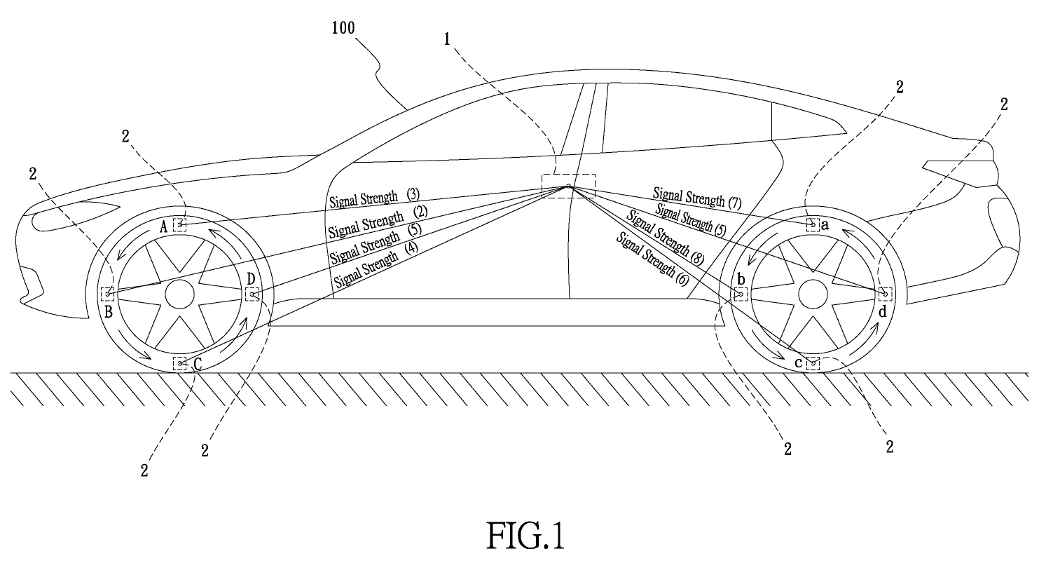

Referring to FIG. 1, in this embodiment the signal receiver 1 is closer to the rear wheels, therefore the basic determination conditions of the signal receiver 1 will be set such that a tire pressure sensor 2 with stronger feedback signal strength is located on a rear wheel, and a tire pressure sensor 2 with weaker feedback signal strength is located on a front wheel. In FIG. 1, for convenience of explanation, four angular positions A, B, C, D are marked on the front wheel through which the feedback signal strength from the front wheel tire pressure sensor 2 passes, and four angular positions a, b, c, d are marked on the rear wheel through which the feedback signal strength from the rear wheel tire pressure sensor 2 passes. It can be seen that when the tire pressure sensor 2 located on the front wheel is at point D and the tire pressure sensor 2 located on the rear wheel is at point d, the feedback signal strength will both be 5. Therefore, at this stage the signal receiver 1 cannot immediately determine the position to which each tire pressure sensor 2 belongs, and still needs to read the signal strength feedback from each tire pressure sensor 2 at multiple angular positions. For example, after reading the signal strength fed back by the tire pressure sensor 2 at positions A, B, C, D, the total signal strength value is 14 (2+3+4+5), and after reading the signal strength fed back by the tire pressure sensor 2 at positions a, b, c, d, the total signal strength value is 26 (5+6+7+8). By comparing the total signal strength values, it can be determined that the tire pressure sensor 2 feeding back at positions A, B, C, D is located on the front wheel (overall weaker signal), while the tire pressure sensor 2 feeding back at positions a, b, c, d is located on the rear wheel (overall stronger signal). Therefore, the optimal angular position for the front wheel tire pressure sensor 2 will be set at point B where the signal feedback is weakest, while the optimal angular position for the rear wheel tire pressure sensor 2 will be set at point b where the signal feedback is strongest.

In this way, when the signal receiver 1 subsequently performs front and rear wheel position determination for each tire pressure sensor 2, it will only determine the strength of signals sent by each tire pressure sensor 2 at the optimal angular position, thereby improving upon the previous positioning method of using the strength of signals returned by the tire pressure sensors 2 to determine the front and rear orientations of the tire pressure sensors 2, which had the problem that misjudgment of front and rear wheel positions would occur under specific circumstances. The method provided by the present invention indeed possesses novelty and inventiveness.

While we have shown and described the embodiment in accordance with the present invention, it should be clear to those skilled in the art that further embodiments may be made without departing from the scope of the present invention.

What is claimed is:

1. A method for automatically determining positioning signal strength in a tire pressure sensor system, comprising the following steps:
a signal receiver setting front and rear wheel determination conditions according to its installation position on a vehicle body, when the signal receiver is installed at a position on the vehicle body closer to the front wheels, the front and rear wheel determination conditions are that a tire pressure sensor with stronger feedback signal strength is located on a front wheel, and a tire pressure sensor with weaker feedback signal strength is located on a rear wheel, when the signal receiver is installed at a position on the vehicle body closer to the rear wheels, a tire pressure sensor with stronger feedback signal strength is located on a rear wheel, and a tire pressure sensor with weaker feedback signal strength is located on a front wheel, when the vehicle body starts moving, the signal receiver receives signal strength feedback from each tire pressure sensor at multiple angular positions, the signal receiver determines an optimal angular position for reading signal strength of each tire pressure sensor based on the signal strength feedback from each tire pressure sensor at the multiple angular positions, determination conditions for an optimal angular position are that the optimal angular position of a tire pressure sensor having overall stronger signal strength feedback at various angles is the angular position when the strongest signal is fed back, and an optimal angular position of a tire pressure sensor having overall weaker signal strength feedback at various angles is the angular position when the weakest signal is fed back.

2. The method for automatically determining positioning signal strength in a tire pressure sensor system as claimed in claim 1, wherein each tire pressure sensor detects a current angular position by using an accelerometer, and feeds back an information of the current angular position to the signal receiver.
